(19) United States
(12) Patent Application Publication
(10) Pub. No.: US 2021/0000094 A1
(43) Pub. Date: Jan. 7, 2021

(54) Fishing Lure with Spinning Device

(71) Applicant: Michael Dunbar, Prophetstown, IL (US)

(72) Inventor: Michael Dunbar, Prophetstown, IL (US)

(21) Appl. No.: 16/920,486

(22) Filed: Jul. 3, 2020

Related U.S. Application Data
(60) Provisional application No. 62/870,276, filed on Jul. 3, 2019.

(51) Int. Cl. A01K 85/10

(52) U.S. Cl. CPC A01K 85/10

(57) ABSTRACT

An improved fishing lure with a spinning device is shown and described. The fishing lure with a spinning device includes a hook located at one end of the fishing lure. A shaft is attached to the hook having a spinning device located thereon. At least one spacer device is located on the shaft between the end of the hook and the spinning device. An eyelet is located at an end of the shaft opposite the hook.

### CROSS REFERENCE TO RELATED APPLICATIONS

This application claims the benefit of U.S. Provisional Application No. 62/870,276 filed on Jul. 3, 2019. The above identified patent application is herein incorporated by reference in its entirety to provide continuity of disclosure.

### BACKGROUND OF THE INVENTION

The present invention relates to an improved fishing lure with a spinning device. More particularly, the present invention provides a fishing lure that begins spinning upon contact with water.

Many people enjoy fishing. When fishing, an angler must pick a bait to use that they believe will be most likely to attract fish. There are almost an infinite number of choices when it comes to the type of bait used when fishing. When choosing a bait, an angler may choose a live bait or an artificial bait. A popular type of artificial bait is a spinner bait.

Spinner baits are typically comprised of a hook and a spoon. The spoon will spin as the bait is pulled along. Spinner baits have a drawback, however. The spoon on a traditional spinner bait will not spin until the bait reaches a certain speed in the water. This means that a bait may not attract any fish for the first several feet in the water. This can cause fish to be missed, or worse, scare fish away.

In many instances fish are often times along the bank of a lake, river, or stream. This is also where many underwater plants grow. A major drawback to spinner baits is that the spoon will stop spinning when it hits the underwater plants. This means that the bait will become ineffective in the best area to attract fish. Further, spinner baits may become tangled with plant life. This means that the bait will have to be cleaned before the bait is used again.

Consequently, there is a need for an improvement in the art of fishing lures. The present invention substantially diverges in design elements from the known art while at the same time solves a problem many people face when using artificial lures when fishing. In this regard the present invention substantially fulfills these needs.

### SUMMARY OF THE INVENTION

The present invention provides an improved fishing lure with a spinning device wherein the same can be utilized for providing convenience for the user when using a spinner fishing lure. The fishing lure with a spinning device is comprised of a hook located at one end of the fishing lure. A shaft is attached to the hook having a spinning device located thereon. At least one spacer device is located on the shaft between the end of the hook and the spinning device. An eyelet is located at an end of the shaft opposite the hook.

Another object of the fishing lure with spinning device is to provide a spinning device that is comprised of a spoon and a flanged collar.

Another object of the fishing lure with spinning device is to provide a lure with a weight located on the shaft between the hook and the spinning device.

Another object of the fishing lure with spinning device is to provide a lure where the hook is a treble hook.

Another object of the fishing lure with spinning device is to provide lure with a tail attachment that is coupled to the hook.

Another object of the fishing lure with spinning device is to provide a lure with the tail attachment further coupled to the shaft.

Another object of the fishing lure with spinning device is to provide a lure with a skirt attached to the shaft, wherein the skirt hangs down toward the hook.

Another object of the fishing lure with spinning device is to provide a lure with a second skirt positioned below the first skirt.

Another object of the fishing lure with spinning device is to provide a skirt that is comprised of a plurality of flexible fibers.

Another object of the fishing lure with spinning device is to provide a lure where the spoon has a flash element thereon.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the fishing lure with spinning device.

FIG. 2 shows an exploded view of an embodiment of the fishing lure with spinning device.

FIG. 3 shows a perspective view of an alternative embodiment of the fishing lure with spinning device.

FIG. 4 shows a perspective view of an alternative embodiment of the fishing lure with spinning device.

FIG. 5 shows a perspective view of an embodiment of a leader with spinning device.

### LIST OF REFERENCE NUMERALS

With regard to the reference numerals used, the following numbering is used throughout the drawings.
101 Spinning device
101a Eye
101b Irregular surface
101c aperture
102 Elongated rod
102a Eye hole
103 Fishing hook
104a First lure skirt
104b Second lure skirt
201 spinning device spacer
202 Spacer beads
203 Fishing weight
204 Tail section
205 Fastener
500 Leader device
501 Leader line
502 Loops
503 Crimps

### DETAILED DESCRIPTION OF THE INVENTION

Reference is made herein to the attached drawings. Like reference numerals are used throughout the drawings to depict like or similar elements of the improved fishing lure with a spinning device. For the purposes of presenting a brief and clear description of the present invention, a preferred embodiment will be discussed as used for the improved fishing lure with a spinning device. The figures are intended for representative purposes only and should not be considered to be limiting in any respect.

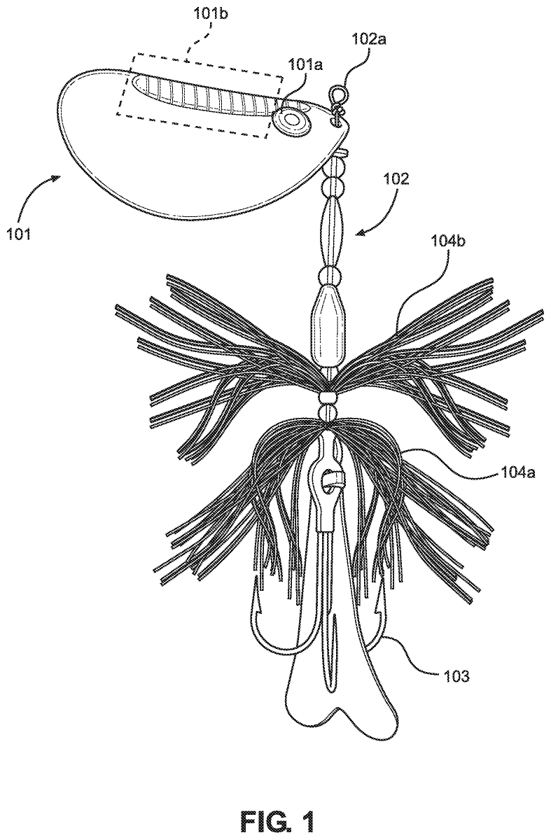

Referring now to FIG. 1, there is shown a perspective view of an embodiment of the fishing lure with spinning device. The fishing lure with spinning device is comprised of a spinning device 101. The spinning device 101 may have different shapes, sizes, designs, and markings. Several different embodiments of the spinning device 101 are descried throughout the specification, these embodiments are in no way limiting, however, some have different benefits over other choices.

In the shown embodiment, the spinning device 101 comprises a Colorado spinning device 101. This means that the spinning device 101 has a larger width and less of a length then some of the other designs. The Colorado design will move a much larger area of water then other types of spinning devices 101. In the shown embodiment, the spinning device 101 has an eye 101a placed thereon. The eye 101a will allow the device to resemble a fish head. The spinning device 101 further has an irregular surface 101b. This irregular surface 101b will allow the spinning device 101 to give of a flashing effect in the water. The flashing effect is given by the reflective surface of the spinning device 101. The reflective surface of the spring device 101 will reflect the suns rays and shine within the water.

The spinning device 101 is rotatably connected to an elongated rod 102. The elongated rod 102 has an eye hole 102a at one end. The eye hole 102a will connect to a fishing line or leader attached to a fishing device. The elongated rod 102 is connected to a fishing hook 103 at an end opposite the eye hole 102a. In the shown embodiment, the fishing hook 103 is a treble hook. Treble hooks have multiple barbs and increase the likely hood of hooking a fish when it strikes the lure. In other embodiments, as shown throughout the fishing hook 103 is a regular hook.

There is at least one lure skirt 104a attached to the elongated rod 102 between the eye hole 102a and the fishing hook 103. The lure skirt 104a is attached to the elongated rod 102 such that it encircles the elongated rod 102 and the fishing hook 103. In some embodiments, there is a second lure skirt 104b attached to the elongated rod 102. The second lure skirt 104b will be attached to the elongated rod 102 similarly to the first lure skirt 104a. The lure skirts 104a, 104b will be placed at different places along the elongated rod 102. The lure skirts 104a, 104b may be made from various different materials in various different colors. In one embodiment, for example, the lure skirts 104a, 104b are made from a rubber material. In another embodiment the lure skirts 104a, 104b are made from animal hair.

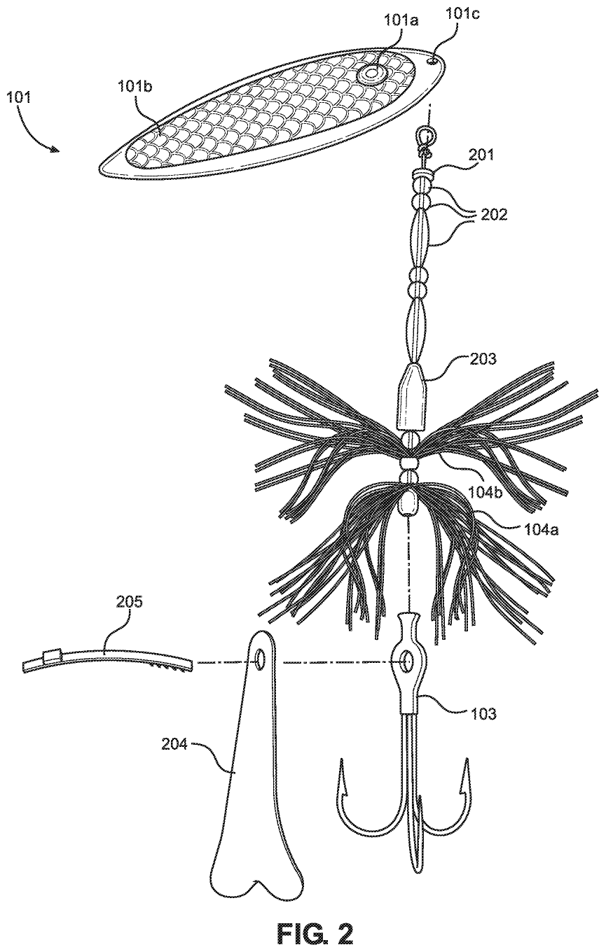

Referring now to FIG. 2, there is shown an exploded view of an embodiment of the fishing lure with spinning device. The spinning device 101 has an aperture 101c therein. The aperture 101c will allow the spinning device 101 to be rotatably coupled directly to the elongated rod 102. In one embodiment, the aperture 101c is cut into the spinning device 101 at an angle. This will allow the spinning device 101 to rotate at a different angle. In the shown embodiment, the spinning device 101 still has an eye 101a located thereon. The spinning device 101 has a larger irregular area 101b located thereon than the embodiment of FIG. 1. This larger irregular section 101b will create more light reflection when in the water. In the shown embodiment, the spinning device 101 is a Texas spinner. This means that the spinning device 101 has a larger length and a thinner width. This will allow the spinning device 101 to cover more of the lure and better represent a fish.

The elongated rod 102 further has a plurality of devices located thereon. The plurality of devices is comprised of a spinning device spacer 201, spacer beads 202, and fishing weights 203. The spinning device spacer 201 is a device that will separate the spinning device 101 from the spacer beads 202. In one embodiment, the spinning device spacer 201 is configured to partially fit within the aperture 101c of the spinning device 101. In one embodiment, the spinning device spacer 201 further functions as a lubrication device. When in the water, the material of the spinning device spacer 201 will have a lubrication quality with the elongated rod 102.

The spacer beads 202 may be in various shapes and sizes. In the shown embodiment the spacer beads 202 are spherical. Further, in the shown embodiment, there are elongated oval spacer beads 202. Spacer beads 202 are used to separate the spinning device 101, the fishing weight 203, the fishing hook 103, and the lure skirts 104a, 104b. In one embodiment, the spacer beads 202 are made from glass. In another embodiment, the spacer beads 202 are made from plastic.

In some embodiments there are fishing weights 203 added to the fishing lure. In many embodiments, the fishing weights 203 comprise lead weights. In some embodiments, the fishing weights 203 are other materials as described below. In the shown embodiment, the fishing weight 203 is a bullet style weight. This form factor will reduce drag in the water. In other embodiments, as described below, the fishing weight 203 is another style.

The fishing lure further is comprised of a tail section 204. In the shown embodiment, the tail section 204 is a strip of material. The strip of material will resemble a fish tail. This will allow the entire lure to resemble a small fish better, thereby attracting bigger fish. In some embodiments, the tail section 204 is secured to the fishing lure using a fastener 205. In other embodiments, as described below, the tail section 204 will be attached differently.

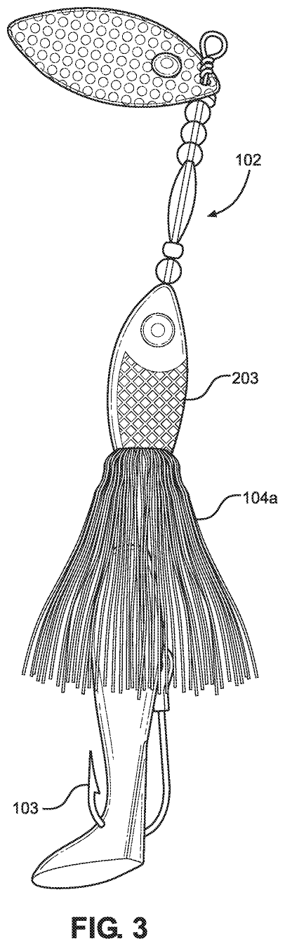

Referring now to FIG. 3, there is shown a perspective view of an alternative embodiment of the fishing lure with spinning device. In the shown embodiment, the lure has several modifications. The fishing weight 203 is shaped to be more fish like. This will allow the fishing lure to have an even more fish like appearance. This can entice larger fish to attach the lure becoming hooked. The fishing weight 203 will look like the head portion of a fish. The fishing weight 203 is secured to the elongated rod 102 of the lure at the head end of the fishing weight 203.

The opposite end of the fishing weight 203 is secured to a lure skirt 104a. The lure skirt 104a will represent a fish body. This will further the fish like appearance. The fishing hook 103 is then secured to the fishing weight 203. In one embodiment, the fishing hook 103 is a single hook. In one embodiment, the fishing hook 103 is hidden by the lure skirt 104a. This will maintain the fish like appearance of the lure.

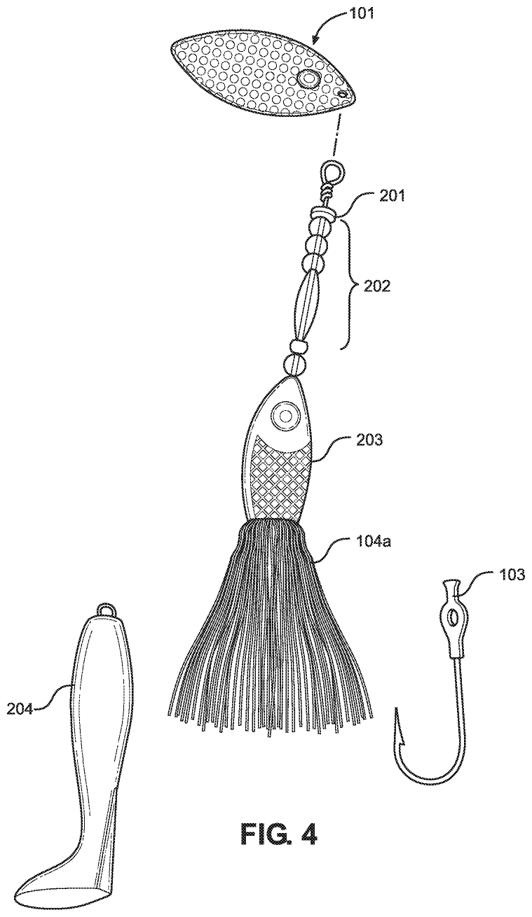

Referring now to FIG. 4, there is shown a perspective view of an alternative embodiment of the fishing lure with spinning device. In the shown embodiment, the tail section 204 is a plastic tail section 204. A plastic is a term of art that one of ordinary skill in the art will understand does not necessarily refer to plastic material. A plastic is an artificial lure made of various materials that represent worms, tails, or other critters to attract fish. In this case, the plastic tail section 204 is configured to move large amounts of water and to swirl as pulled through the water. In other embodiments, other plastic tail sections 204 may be used.

The tail section 204 is secured to the fishing lure via the fishing hook 103. The fishing hook 103 is located through the tail section as shown in FIG. 3. This will ensure that the fishing hook 103 is in a position to catch the fish. Further, this configuration will better secure the tail section 204 to the lure. In some embodiments, the tail section 204 is partially covered by the lure skirt 104a.

The elongated rod is configured similar to the other embodiments. There is a plurality of spacer beads 202 that separate the fishing weight 203 from the spinning device 101. This will allow the spinning device 101 to spin and not interfere with the fish appearance of the rest of the lure. The lure device sits on the spinning device spacer 201. This will ensure that the spinning device 101 functions properly.

In this embodiment, the spinning device 101 is a Colorado spinner. This will have a shorter length allowing the spinning device 101 to function without interfering with the rest of the lure. In different embodiments, different spinning devices 101 may be used. In some embodiments, the elongated rod is of different lengths to allow for different spinning devices 101 to be used.

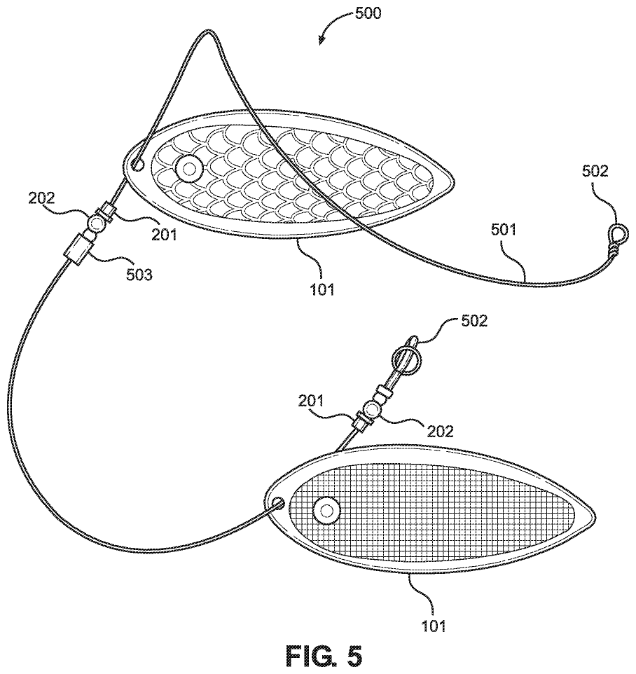

Referring now to FIG. 5, there is shown a perspective view of an embodiment of a leader with spinning device. The leader device 500 is configured to be connected to a fishing lure. This will allow for any lure to be given a spinning device 101 effect causing water to be moved and fish to be attracted. In the shown embodiment, there are no fishing weights or lure skirts included in the leader device 500. These items may be added in different embodiment to create a desired effect.

The leader device 500 includes at least one spinning device 101. In the shown embodiment, there are two sets of spinning devices 101 and bead spacers 202. This means there are two spinning devices 101. This will move even more water. The spinning devices 101 are secured to a leader line 501. The spinning devices 101 each have a spinning device spacer 202 to ensure proper function of the spinning device 101. In one embodiment, there is a crimp 503 located along the leader line 501 to prevent the spinning devices 101 from sliding along the leader line 501 such that the two spinning devices 101 do not contact to each other.

The leader line 501 has loops 502 disposed at both ends thereof. The loops 502 will allow the leader line 501 to be attached to a fishing line or a fishing lure. The loops 502 will also keep the spinning devices 101 secured to the leader line 501. In various embodiments, there are also bead spacers 202 located along the leader line 501. This will allow the spinning devices 101 to be kept in specific places to best move water.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fishing lure with a spinning device, the fishing lure comprising:
a hook located at one end of the fishing lure;
a shaft attached to the fishing hook having a spinning device located thereon;
at least one spacer device located on the shaft between an end of the hook and the spinning device;
an eyelet located at an end of the shaft opposite the hook.

2) The fishing lure of claim 1, wherein the spinning device is comprised of a spoon and a flanged collar.

3) The fishing lure of claim 1, further comprising a weight located on the shaft between the hook and the spinning device.

4) The fishing lure of claim 1, wherein the fishing hook is a treble hook.

5) The fishing lure of claim 1, further comprising a tail attachment that is coupled to the fishing hook.

6) The fishing lure of claim 5, wherein the tail attachment is further coupled to the shaft.

7) The fishing lure of claim 1, further comprising a first skirt attached to the shaft, wherein the skirt extends toward the fishing hook.

8) The fishing lure of claim 7, further comprising a second skirt positioned below the first skirt.

9) The fishing lure of claim 7, wherein the skirt is comprised of a plurality of flexible fibers.

10) The fishing lure of claim 2, wherein the spoon has a flash element thereon.

11) A fishing lure with a spinning device, the fishing lure comprising:
a hook located at one end of the fishing lure;
a length of fishing line attached to the fishing hook having a spinning device located thereon;
at least one spacer device located on the shaft between the end of the hook and the spinning device;
an eyelet located at an end of the length of fishing line opposite the fishing hook.

12) The fishing lure of claim 11, wherein the spinning device is comprised of a spoon and a flanged collar.

13) The fishing lure of claim 11, further comprising a weight located on the length of fishing line between the fishing hook and the spinning device.

14) The fishing lure of claim 11, wherein the fishing hook is a treble hook.

15) The fishing lure of claim 11, further comprising a tail attachment that is coupled to the fishing hook.

16) The fishing lure of claim 15, wherein the tail attachment is further coupled to the length of fishing line.

17) The fishing lure of claim 11, further comprising a skirt attached to the length of fishing line, wherein the skirt hangs down toward the fishing hook.

18) The fishing lure of claim 17, further comprising a second skirt positioned below the skirt.

19) The fishing lure of claim 17, wherein the skirt is comprised of a plurality of flexible fibers.

20) The fishing lure of claim 12, wherein the spoon has a flash element thereon.
